(19) United States
(12) Patent Application Publication
(10) Pub. No.: US 2024/0367025 A1
(43) Pub. Date: Nov. 7, 2024

(54) Covert Visual Haptic Sports Communication System

(71) Applicants: John Richard Bianchini, Suwanee, GA (US); Daniel Joseph Dumey, Jr., Duluth, GA (US); Samuel Thomas Sander, Suwanee, GA (US)

(72) Inventors: John Richard Bianchini, Suwanee, GA (US); Daniel Joseph Dumey, Jr., Duluth, GA (US); Samuel Thomas Sander, Suwanee, GA (US)

(21) Appl. No.: 18/655,226

(22) Filed: May 4, 2024

Related U.S. Application Data
(60) Provisional application No. 63/500,561, filed on May 5, 2023.

(51) Int. Cl. A63B 71/06; A63B 102/18; G06F 3/01; G06F 3/0354; G06F 3/0362; G06V 40/13

(52) U.S. Cl. CPC A63B 71/0622; G06F 3/016; G06F 3/03547; G06F 3/0362; A63B 2071/0655; A63B 2071/0666; A63B 2102/18; A63B 2225/50; G06V 40/13

(57) ABSTRACT

A covert visual and vibrotactile communication system for use in sports environments where there is a stoppage in play and covert communication is necessary in proximity to a competitor or unintended observer having one or more participant units, each participant unit including at least one finger swiping device, at least one vibrotactile haptic device, at least one hands-free visual interface; a biometric identification system; and a central processing unit having at least one processor and memory. Each central processing unit is networkable with the finger swiping unit; the vibrotactile haptic device and the visual interface. The system is networkable with other participant units and other external transmitting units. The invention serves to provide covert communication among coaches and players allowing communication without the use of hand signals or auditory signals, and is not subject to ambient noise or any other interference common in sporting environments.

### CROSS-REFERENCE TO RELATED APPLICATIONS

The present utility patent application claims priority benefit of the U.S. provisional application for patent Ser. No. 63/500,561 titled “Covert Visual Haptic Sports Communication System” filed on May 5, 2023 under 35 U.S.C. 119 (e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates generally to the field of sports communication systems. More specifically, the present invention relates to a covert haptic sports communication system.

### 2. Description of the Related Art

In most team sports, there is a genuine advantage to having secure and covert communication which cannot be intercepted by an opposing player or an opposing team. Such communication includes, but is not limited to, player-to-player and coach-to-player communication. In baseball, for example, a coach signals to one or more players to employ a desired defensive strategy, and a pitcher and catcher directly communicate plans for the next pitch. There are various pitch selections to communicate, such as fastballs, curveballs, etc. The catcher and pitcher also need to communicate the location of the pitch (i.e. low, middle, up, inside, outside). Traditionally, this communication was achieved with standard hand signals from the catcher in view of the pitcher. In this case, the batter is able to see the pitcher's negative or positive acknowledgment but is not able to determine the message.

During a live sports competition, hand signals can be seen by many observers on the field, in the stands, or from the opposing team's dugout or sideline. Consequently, these hand signals need to be changed frequently to minimize the risk of the other team deciphering them by observing repetition of the signal and the resulting pitch or play call. The opposing team can employ several agents to observe, decipher, and relay the upcoming pitch to the batter by visual or auditory means. Knowing what pitch is planned does not guarantee a hit, but a batter's odds significantly increase if one team steals another team's signals and if the former is able to relay the signal to the hitter.

In many team sports such as football and auto racing, there are already various discreet voice/audio radio communication systems in use. Traditional voice/radio systems require the coach/crew chief to speak in view of cameras and spectators, risking their lips being read. This risk often applies to players as well. Coaches and players can block their mouths from view to prevent lipreading, but it still leaves them vulnerable to eavesdropping.

A system by Hankins et al. was recently introduced to address the need for covert sports communication. In such a system, a sender pushes buttons to select pre-recorded audio messages to be played to the receiver. Although such a system is an improvement over hand signaling, two significant shortcomings present themselves. First, live sports events are subject to high levels of crowd noise, which can be intentionally used by fans of the home team to disrupt the opposing team's players from hearing an audio signal. Second, the use of static button positions to communicate specific messages present another opportunity for independent observers to see which button is pressed, decipher the message, and inform the opponent. In baseball, for example, a batter could possibly see which buttons a catcher is selecting, which would give the batter an opportunity to predict the type of incoming pitch.

At present, no such invention exists which overcomes the limitations of such button utilizing systems. Based on the foregoing, there clearly exists a need for such an improved sports communication system.

### SUMMARY

The present invention fulfills the need for an improved system and method for haptic sports communication. Embodiments of the invention provide covert communication among coaches and players allowing communication without the use of hand signals or auditory signals, and is not subject to ambient noise or any other interference common in sporting environments.

At its essence, the invention comprises a covert input device, a vibrotactile haptic device, and a hands-free visual interface. A transmitting device which can serve as a computer or central processing unit is also implemented into the invention. Other peripheral devices such as, but not limited to, a fingerprint sensor can also be included.

The invention also includes a covert input device. Such a covert input device can utilize a finger swiping device allows for players to communicate covert messages with one or more other players and/or coaches by creating finger swiping gestures which are used to select the messages to be sent to intended persons. The swiping motion cannot be interpreted without knowing the initial state, which is unknown to an observer (e.g. through random initialization). In contrast to pressing buttons which can be understood by observers, using a finger swiping device enables players and or coaches to create covert messages which are much more difficult to decipher. Other covert input devices can include, but are not limited to, navigational buttons and scrolling wheels.

The vibrotactile haptic device employs a vibrotactile haptic communication system to be used in a sports environment where covert communications are beneficial and permitted. The vibrotactile haptic device can employ a vibration motor and a pulsed width modulation switching system. The use of a vibrotactile haptic communication system covertly alerts players of incoming messages and notifications.

The invention further includes a hands-free visual interface which may consist of a heads-up display (HUD) which superimposes messages in a player's view, so the player does not have to move his or her head to view the message. A player can view messages while not impairing a player's field of vision. In other words, a player would not have to look away from the game or field to view a message. The HUD also provides confidentiality since the view would be unintelligible to even a close observer. In other embodiments of the invention, a glove or arm-mounted display with privacy features is also supported if required or preferred. Other embodiments can include, but are not limited to, augmented reality glasses.

The invention includes a transmitting device which is able to send signals to the vibrotactile haptic device, the hands-free visual interface, the covert input device, and other peripheral components utilized by the system. Such a transmitting device includes at least one processor and memory having computer executable instructions which can serve as a computer system in which the covert visual haptic sports communication system is integrated and implemented. The transmitting device can be networked with receiving devices as well as other transmitting devices.

The invention can include a receiving device which is able to receive signals from a transmitting device, and send signals to the hands-free visual interface, the covert input device, and other peripheral components utilized by the system. Such a receiving device includes at least one processor and memory having computer executable instructions which can serve as a computer system in which the covert visual haptic sports communication system is integrated and implemented. The receiving device can be networked with receiving devices as well as other transmitting devices.

Private visualization is provided by heads-up display projection, augmented reality display, and display privacy measures. Private user input is achieved through the use of an external slider input device. These features and other state-of-the-art wearable computing technologies are combined to support game strategy and game state communication through a confidential and convenient-to-use interface.

The covert visual haptic sports communication system eliminates the need for hand gestures and audio signals. The system further allows players and/or coaches to communicate visual messages privately and securely such that an observer with direct view of the user would not be able to determine a message sent over the system.

It is an object of the invention to provide a covert display system which gives a user viewing capability in full sunlight while limiting the viewing angle to prevent an unintended viewer from observing the display. Such a system allows a user to privately view instructions or signals on a display which does not obscure a user's full field of vision.

It is a further object of the invention to provide a system which does not use audio. A covert visual and vibrotactile haptic communication system must be able to function in a noisy environment and must not create sound which can be heard by others.

It is another object of the invention to provide a system which incorporates touch-based swiping to send real-time messages to teammates and/or coaches. Such a system will not use buttons or visible devices that are capable of being observed and recognized by observers.

Another object of the invention is to provide vibrotactile haptic feedback to inform a user of new information available on a display. By employing a vibrotactile system, both players and coaches alike can be alerted to new messages without being noticed by observers from other teams whether on the field or in the stands. Vibrotactile integration could also extend to referees and umpires for enhanced communication.

An additional object of the invention is to provide biometric authentication for accessing the devices or system. Such authentication can be used for player identification, auditing purposes, player preferences, or security in case any device is lost, stolen or cloned.

A final object of the invention is to ensure the privacy and security of any communications sent over a network. By way of example, and not limitation, the system will provide end-to-end encryption of any signals sent over a network.

The visual and vibrotactile haptic communication system can be sold as premanufactured components or can be customized for specific sports and specific positions.

The visual and vibrotactile haptic communication system can be used for a variety of purposes. The system is well suited for competitions where there is a pause in the action between each play, such as in baseball or football. In baseball, selecting and communicating a pitch is an essential game strategy. In football, the system would enable communicating plays without the need for a huddle or obfuscated calls from a quarterback or coach.

### BRIEF DESCRIPTION OF THE DRAWINGS

The invention directed by way of example, and not by way of limitation, in the figures of the accompanying drawings and in which like reference numerals refer to similar elements and in which:

FIG. 1 illustrates a diagram of a covert visual and vibrotactile haptic communication system in accordance with an embodiment of the invention;

FIG. 2 illustrates a network and server diagram in which the exemplary covert visual and vibrotactile haptic communication system may be implemented;

FIG. 3 is a block diagram of a typical computer system that, when appropriately configured or designed, may serve as a computer system for which the controller unit of the covert visual and vibrotactile haptic communication system, and the components thereof, may be embodied;

FIG. 4 illustrates an additional network diagram in which the exemplary covert visual and vibrotactile haptic communication system may be implemented;

FIG. 5A illustrates a dual external touch slider input device which can serve as a sending unit, a receiving unit, or a general computer for the covert visual and vibrotactile haptic communication system in accordance with an embodiment of the invention;

FIG. 5B illustrates an input device configured to transmit data in accordance with an embodiment of the invention;

FIG. 6 illustrates a baseball glove with an external touch slider unit attached;

FIG. 7 illustrates a pair of augmented reality eyeglasses in which a hands-free visual interface of the covert visual and vibrotactile haptic communication system can be embodied;

FIG. 8 illustrates a baseball hat with a hands-free visual interface attached.

FIG. 9 illustrates a baseball catcher's mask with a hands-free visual interface attached; and

FIG. 10 illustrates a baseball catcher utilizing the covert visual and vibrotactile haptic communication system in accordance with an embodiment of the invention.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “one variant,” “an embodiment,” “a variant,” “various embodiments,” “numerous variants,” etc., may indicate that the embodiment(s) of the invention so described may include particular features, structures, or characteristics. However, not every embodiment or variant necessarily includes the particular features, structures, or characteristics. Further, repeated use of the phrase “in one embodiment,” or “in an exemplary embodiment,” or “a variant,” or “another variant,” do not necessarily refer to the same embodiment although they may. A description of an embodiment with several components in communication with each other does not imply that all such components are required. On the contrary, a variety of optional components are described to illustrate the wide variety of possible embodiments and/or variants of the present invention.

A “head-up display,” or “heads-up display,” also known as a “HUD” is any transparent display that presents data without requiring users to look away from their usual viewpoints. The origin of the name stems from an airplane pilot being able to view information with the head positioned “up” and looking forward, instead of angled down looking at lower instruments. A HUD also has the advantage that a user's eyes do not need to refocus to view a wider field of view after looking at an optically nearer instrument.

“Haptic technology” (also kinesthetic communication or 3D touch) is technology that can create an experience of touch by applying forces, vibrations, or motions to a user. Such technology can be used to create virtual objects in a computer simulation, to control virtual objects, and to enhance remote control of machines and devices (telerobotics). Haptic devices may incorporate tactile sensors that measure forces exerted by the user on the interface. Simple haptic devices are common in the form of game controllers, joysticks, and steering wheels.

“Augmented reality” (AR) is an interactive experience that combines real world and computer-generated content. The content can span multiple sensory modalities, including visual, auditory, haptic, somatosensory, and olfactory. AR can be defined as a system that incorporates three basic features: a combination of real and virtual worlds, real-time interaction, and accurate 3D registration of virtual and real objects. The overlaid sensory information can be constructive (i.e. additive to the natural environment), or destructive (i.e. masking of the natural environment). This experience is seamlessly interwoven with the physical world such that it is perceived as an immersive aspect of the real environment. In this way, augmented reality alters one's ongoing perception of a real-world environment, whereas virtual reality completely replaces the user's real-world environment with a simulated one.

A “computer” may refer to one or more apparatus and/or one or more systems that are capable of accepting a structured input, processing the structured input according to prescribed rules, and producing results of the processing as output. Examples of a computer may include: a personal computer (PC); a stationary and/or portable computer; a computer having a single processor, a computer having multiple processors, or a computer having multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer; a personal digital assistant (PDA); a portable telephone; a portable smartphone; wearable devices such as smartwatches; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

The term “processor” may refer to any device or portion of a device that processes electronic data from registers and/or memory to transform that electronic data into other electronic data that may be stored in registers and/or memory. A “computing platform” may comprise one or more processors.

A “microcontroller” generally refers to a small computer on a single integrated circuit. A microcontroller contains one or more central processing units (processor cores) along with memory and programmable input/output peripherals. A typical microcontroller includes a processor, memory and input/output (I/O) peripherals on a single chip.

An “algorithm” is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

It will be readily understood by persons skilled in the art that the various methods and algorithms described herein may be implemented by appropriately programmed computers, microcontrollers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

“Software” may refer to prescribed rules and/or instructions used to operate a computer. Non-limiting examples of software may include: Code segments in one or more computer-readable languages; graphical and or/textual instructions; applets; pre-compiled code; interpreted code; compiled code; and computer programs. An operating system or “OS” is software that manages computer hardware and software resources and provides common services for computer programs.

Certain embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including object-oriented programming languages and/or conventional procedural programming languages, and/or programming languages or other compilers, assemblers, interpreters or other computer languages or platforms.

A “computer system” may refer to a system having one or more computers, where each computer may include a computer-readable medium employing software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a plurality of computers and associated devices that may be connected by communication channels to facilitate communication and resource sharing. A network may involve permanent connections such as cables or temporary connections such as those made through telephone, cable, wireless or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include, but are not limited to, an internet, such as the Internet or World Wide Web; an intranet; a personal area network (PAN); near field communication (NFC); Bluetooth; a local area network (LAN); a wide area network (WAN); a virtual private network (VPN); internet of things (IoT); and a combination of networks, such as an internet and an intranet.

An “IoT embedded system” consists of one or more computers built for a custom purpose. Such computers typically consist of a microprocessor, memory and input/output peripherals. An embedded system typically has internet connectivity, and the devices associated with such a system are referred to as “smart devices.” Such devices typically have some type of software installed in order for the devices to perform their respective functions.

Aspects of the exemplary covert visual and vibrotactile haptic communication system will be described below with reference to flowchart illustrations and/or block diagrams of methods, steps, apparatus (systems) and computer program products according to embodiments of the invention. Persons skilled in the art will understand that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, microcontroller, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods, and computer program products according to various embodiments of the exemplary covert visual and vibrotactile haptic communication system. It will become readily apparent to persons skilled in the art that each block in the flowchart or block diagrams may represent a module, segment, or portion of code, which comprises one or more executable instructions for implementing the specified logical function(s). It will also be readily apparent to persons skilled in the art that in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any practical order.

It will also be understood by persons skilled in the art that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It will be readily understood by persons skilled in the art that the various methods and algorithms described herein may be implemented by appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

As is well known to those skilled in the art, many careful considerations and compromises typically must be made when designing the optimal manufacture or commercial implementation of such a covert visual and vibrotactile haptic communication system. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

The exemplary covert visual and vibrotactile haptic communication system will now be described in detail with reference to embodiments thereof as illustrated in the accompanying drawings. Unless otherwise indicated illustrations in the figures are not necessarily drawn to scale.

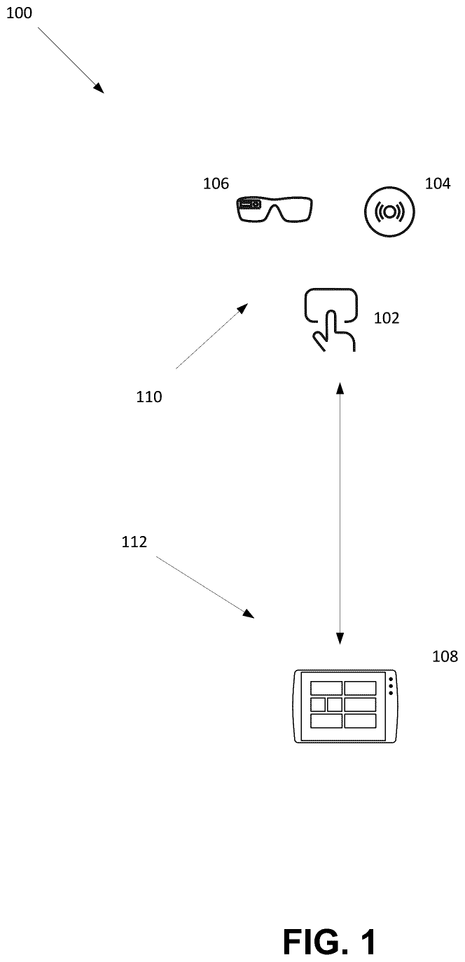

FIG. 1 illustrates a block diagram of an exemplary covert visual and vibrotactile communication system for use in sports environments 100 in accordance with an embodiment of the invention. At its essence, the invention comprises a covert input device 102, a vibrotactile haptic device 104, and a hands-free visual interface 106. As standalone units, the covert input device, the vibrotactile haptic device, and the hands-free visual interface can be configured and programmed in such a way so as to communicate with other standalone units. In one embodiment of the invention, the covert input device, the vibrotactile haptic device, and the hands-free visual interface employ a short-range wireless communication system such as Bluetooth®. The system can further be configured to communicate with a central processing unit or computer. Likewise, the central processing unit or computer can communicate with the covert input device, the vibrotactile haptic device, and the hands-free visual interface via short-range wireless communication system such as Bluetooth®. The central processing unit or computer can be configured to communicate with a transmitting device and a receiving device so as to provide an additional layer. Persons skilled in the art will appreciate that other wired and wireless communication systems are available and can be readily implemented in the covert visual and vibrotactile communication system.

In one embodiment of the invention, the system incorporates a covert input device 102 using an external touchpad to send real-time messages among teammates. In a preferred embodiment of the invention, the covert input device consists of one or more touch pad units where a player or coach can make simple finger gestures on the pad which can be understood by other players when transmitted over a network. Persons skilled in the art will understand that a touchpad is a type of pointing device which includes a tactile sensor. A typical tactile sensor is an electronic device with a flat surface, that detects the motion and position of a user's fingers, and translates them to a position on a screen, to either control a pointer in a graphical user interface or to provide a user a means of operating one or more switches. In various embodiments of the invention, he covert input device can be similar to a touchpad on a laptop computer, but packaged as a small, self-contained square or rectangular unit. Other user-input navigation devices can be used in place of the touchpad input (e.g. including, but not limited to, scroll-wheel(s), pointing devices, gaze tracking). The external touch device separates visual feedback from the device for convenience and privacy. For convenience, the touch device can be attached wherever a player's hand is most conveniently placed per the player's preference, independent of the visual display. By way of example, and not limitation, an external touchpad can be placed on a baseball catcher's leg or on the back of a catcher's glove. Since there is no visual representation and no static locations on the touch device, an observer can only see general swiping motions which cannot be attributed to any specific message regardless of an observer's viewpoint (e.g. a batter next to a catcher).

In one embodiment of the invention, the covert input device is a Synaptics® TouchPad unit. In one embodiment of the invention, the covert input device consists of two touch pad units. Such units can be accompanied with additional components to wirelessly communicate with a central processing unit, microcontroller unit or other receiving unit. Persons skilled in the art will appreciate that such a covert input device can be incorporated into the system separate from the display, or can be integrated into a display such as, but not limited to, the HiLetgo® 2.4″ SPI TFT LCD Display 2.4 Inch ILI9341 touch panel LCD.

In one embodiment of the invention, a covert input device with a display is integrated into a pitcher's glove. Such a display and covert input device enables a pitcher to engage in two-way communication with a catcher, manager or other coach. To accommodate the user's desired hand placement and better support display privacy, it is often preferable to separate the input device and the display. In other embodiments of the invention, such a finger swiping input could be integrated into a wristband or armband. In another embodiment, a covert input device can be integrated into sports pads such as thigh pads, knee pads, or arm pads.

The system further incorporates a haptic device 104. User information is sent to a player both visually and haptically. Such a haptic interface sends a vibrotactile signal produced by a motor in the display to induce a tactile vibration sensation to alert the player that new information is present on the display. The vibrotactile signal can be configured with various patterns and intensities or even disabled based on the message type and context.

In one embodiment of the invention, the haptic device 104 consists of a vibration motor and pulse width modulation driver module assembly. Such haptic devices are well known and appreciated in the art, and can be configured to integrate with a CPU or microcontroller unit. As a component of an IoT embedded system, a haptic device allows for players to receive covert messages with one or more other players and/or coaches from other devices on the covert vibrotactile sports communication system which are only understood by intended persons.

The system further incorporates a hands-free visual interface 106. Such an interface consists of, but is not limited to, heads-up displays (HUDs), angle restricted opaque displays, or augmented reality (AR) glasses. The hands-free visual interface can be selected based on a player's needs or personal preference. However, it is important to provide a display which provides the most unobtrusive viewing option. In the case of the HUD or AR display, the display is superimposed in a player's view such that the player does not need to move his or her head to view whatever message is displayed. More importantly, though, any message can be displayed without obstructing a player's field of vision.

In embodiments of the invention, the HUD can be cap or mask mounted. The HUD requires a larger optical path than AR glasses, but may be more desirable for a player who does not want to wear glasses. The arm or glove mounted opaque display provides another option to maximize a player's comfort within the system. The system can use a variety of display technologies including, but not limited to, thin-film transistor liquid crystal display (TFT LCD), organic light emitting diode (OLED), and electrophoretic displays (EPD) depending on the display requirements. The display can be monochromatic or color. In other embodiments of the invention, three-dimensional or holographic displays can be employed.

In one embodiment of the invention, the heads-up display is configured for use on a baseball cap, a face mask (used in baseball, football, hockey and lacrosse), or helmet. Such a configuration uses a commercially available OLED display along with a custom-built optical path utilizing mirrors and lenses to create a heads-up display which does not interfere with a player's field of vision. Embodiments of the invention may employ a display unit such as, but not limited to, the HiLetgo 0.91″I2C Serial OLED LCD Display SSD1306 128×32. Persons having skill in the art will readily appreciate that other such display units compatible with known microprocessor and/or microcontroller units may be utilized. In other embodiments of the invention, augmented reality glasses which employ a micro-projection system that discretely integrates into eyewear such as, but not limited to ActiveLook® equipped sports eyewear.

In embodiments of the invention, a receiving device 110 is able to receive signals from a transmitting device, and send signals to the covert input device 102, the vibrotactile haptic device 104, the hands-free visual interface 106, and other peripheral components utilized by the system. As a component of an IoT embedded system, a receiving device allows for players to receive covert messages with one or more other players and/or coaches from other devices on the covert vibrotactile sports communication system which are only understood by intended persons. Such a receiving device includes at least one processor and memory having computer executable instructions which can serve as a computer system in which the covert visual haptic sports communication system is integrated and implemented. The receiving device can be networked with receiving devices as well as other transmitting devices. Persons skilled in the art will appreciate the availability of numerous encryption methods available to establish secure and encrypted communications between the covert input device 102, the vibrotactile haptic device 104, and the hands-free visual interface 106, and a receiving device 110 such as, but not limited to, symmetric key ciphers, asymmetric key cyphers, elliptical curve cryptography (ECC), and advanced encryption standard (AES).

The housing for the receiving device 110 would be, ideally, unibody construction where the only entrance points for moisture or dust would be the vibrohaptic mechanism and an access point for a power source and/or networking cables. Each of those points would have some form of polymeric or other malleable seal, be it rubber, silicon, composite or the like, to prevent foreign object debris or moisture intrusion. Moreover, the receiving device will be heat-resistant, waterproof, sweat-proof and capable of withstanding numerous shocks and falls encountered during sporting events.

Additionally, in some embodiments, the receiving device 110 may include wearable wireless devices like wrist bands and ankle bands, or may be integrated into player jerseys, belts, or uniforms. In one embodiment, the receiving device 110 may be designed to be worn on the forearm with the device against the inside (palm side) of the arm. This location provides the greatest level of sensitivity by the wearer and would allow them to discern even slight vibration

The system can include a transmitting device 112 which is able to send signals to the vibrotactile haptic device, the hands-free visual interface, the covert input device, and other peripheral components utilized by the system. As a component of an IoT embedded system, a transmitting device allows for players and other personnel to send covert messages with one or more other players and/or coaches from other devices on the covert vibrotactile sports communication system which are to be understood by intended persons. Such a transmitting device includes at least one processor and memory having computer executable instructions which can serve as a computer system in which the covert visual haptic sports communication system is integrated and implemented. The transmitting device can be networked with receiving devices as well as other transmitting devices. In one embodiment, the transmitting device can be a touch pad display. In another embodiment, the transmitting device can be a tablet. In another embodiment, the transmitting device can be a smartphone having custom software and/or firmware. In another embodiment, the transmitting device can be a laptop computer. Persons having skill in the art will readily appreciate the numerous means and methods in which a transmitting device can be configured and implemented so as to provide vibrotactile haptic signals and visual signals to a receiving device. In embodiments of the invention, the transmitting device 112 can include all the features of the receiving device 110. Persons skilled in the art will appreciate the availability of numerous encryption methods available to establish secure and encrypted communications between the covert input device 102, the vibrotactile haptic device 104, and the hands-free visual interface 106, and a transmitting device 112 such as, but not limited to, symmetric key ciphers, asymmetric key cyphers, elliptical curve cryptography (ECC), and advanced encryption standard (AES).

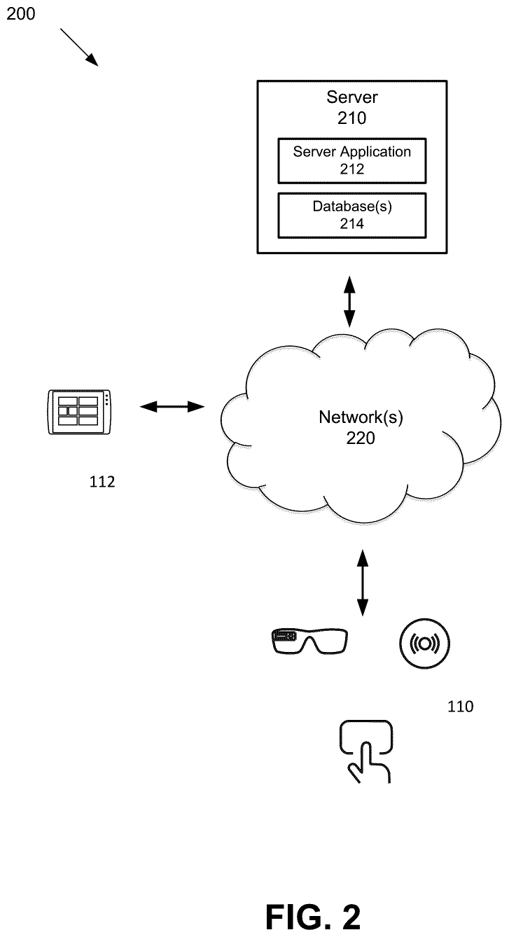

FIG. 2 illustrates a network diagram 200 for a covert visual and vibrotactile communication system for use in sports environments 100, according to an embodiment of the invention. A network(s) 220 may comprise a local area network LAN and/or a wide area network WAN (e.g., the Internet) and can comprise a private and/or public network. For example, in an implementation the entire network 200 is located within a sports stadium and can be implemented by way of a router or cellular network. The network(s) 220 may consist of a secured single local area network having end-to-end encryption. The system 100 can be implemented in location-specific venues or can be implemented as a purely online system.

In various embodiments, the network 220 can include wired, optical and/or wireless links and the network elements etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing access and network management and for supporting other network functions.

In one embodiment of the invention, one or more servers 210 may communicate with a transmitter unit 112 and a receiver unit 110 using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. Persons having skill in the art will appreciate that numerous transmission protocols can be employed in a successful implementation of the covert visual and vibrotactile communication system for use in sports environments. While the server 210 is illustrated as being connected to various systems through a single set of network(s) 220, the server 210 may be connected to the various systems via different sets of one or more networks. In embodiments of the invention, a visiting team can configure a wireless network at a particular sports venue using security protocols such as, but not limited to, end-to-end encryption and two-factor authentication.

The server 210 may comprise any type or types of computing devices capable of wired and/or wireless communication, including without limitation, computer hardware and/or server platforms, desktop computers, laptop computers, tablet computers, smart phones or other mobile phones, electronic kiosks, and/or the like. Transmitter units 112 and receiver units 110 may be “thin,” in which case processing is primarily carried out server-side by server application 210. For example, the system may be a browser application which renders the graphical user interface generated by either the server application 210 or software from the server itself. Server application 210 may transmit or serve one or more screens of the graphical user interface in each receiver unit 110. In some embodiments, these screens may be served in the form of a wizard, in which case two or more screens may be served in a sequential manner, and one or more of the sequential screens may depend on an interaction of the user with one or more preceding screens. The requests to server 210 and the responses from the server application 212, including the screens of the graphical user interface, may both be communicated through network(s) 220 using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 214) that are locally and/or remotely accessible to server 210. In an embodiment, a player may utilize a touch panel display 102 which allows users (e.g., players or referees) to perform touch operations to input elements of the graphical user interface. Alternatively, the receiving unit 112 may comprise a non-touch-sensitive display with standard hardware inputs. Non-limiting examples include personal computer platforms, tablets, and smartphones.

The server 210 may comprise, be communicatively coupled with, or otherwise have access to one or more database(s) 214. For example, the server 210 may comprise one or more database servers which manage one or more databases 214. A player's system, executing on the server 210, may submit data (e.g., user data, form data, etc.) to be stored in database(s) 214, and/or request access to data stored in database(s) 214. Any suitable database may be utilized, including without limitation MySQL™, Oracle™, IBM™, Microsoft SQL™, Access™, and the like, including cloud-based databases and proprietary databases. Data may be sent to a server 210, for instance, using the well-known POST request supported by HTTP, via FTP, and/or the like. This data, as well as other requests, may be handled, for example, by server-side web technology, such as a servlet or other software module (e.g., comprised in server application 210), executed by such server 210.

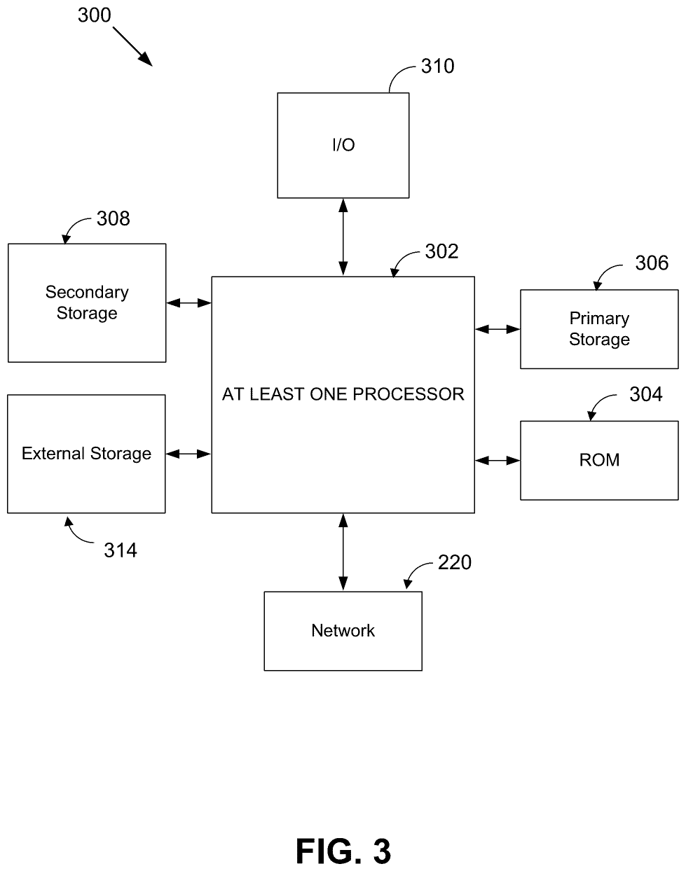

FIG. 3 illustrates a typical computer system that, when appropriately configured or designed, may serve as a computer system for which the computers of the covert visual and vibrotactile haptic communication system, and the components thereof, be embodied. The computer system 300 includes at least one processor 302 (also referred to as central processing units, or CPUs) that may be coupled to storage devices including a primary storage 306 (typically a random-access memory, or RAM), a primary storage 304 (typically a read-only memory, or ROM). CPU 302 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors. As is well known in the art, primary storage 304 acts to transfer data and instructions uni-directionally or bi-directionally to the CPU and primary storage 306 typically may be used to transfer data and instructions in a bi-directional manner. The primary storage devices discussed previously may include any suitable computer-readable media known and appreciated in the art. An external storage device 308 may also be coupled bi-directionally to the central processing unit (CPU) 302 and provides additional data storage capacity and may include any of the computer-readable media described above. Mass storage device 308 may be used to store programs, data and the like and typically may be used as a secondary storage medium such as a hard disk or a flash drive. It will be appreciated that the information retained within external storage device 308, may, in appropriate cases, be incorporated in standard fashion as part of primary storage 306 as virtual memory.

The central processing is coupled to the various components 310 of the invention such as the covert input device, the vibrotactile haptic device, and the hands-free visual interface. The CPU can also be configured to operate the fingerprint sensor and the transmission device. The CPU 302 may also be coupled to an input/output interface that connects to one or more input/output devices such as buttons, track balls, mice, keyboards, touch pads, microphones, touch-sensitive displays, transducer card readers, magnetic or paper tape readers, smartphones, tablets, styluses, voice or handwriting recognizers, or other well-known input devices such as, of course, other computers. The CPU is also coupled to various output devices such as, but not limited to, displays, monitors, various LED, OLED, and LCD displays, heads-up displays (HUDs), speakers, haptic vibration devices, or other well-known output devices such as other computers, tablets and smartphones. The CPU 302 may also be coupled to an interface 314 which connects to external storage devices such as flash memory and/or the cloud. Finally, the CPU 302 optionally may be coupled to an external device such as a database or a computer, tablet, smartphone, or internet network using an external connection shown generally as a network 220, which may be implemented as a hardwired or wireless communications link using suitable conventional technologies. With such a connection, the CPU 302 might receive information from the network, or might output information to the network in the course of performing the method steps described in the teachings of the present invention.

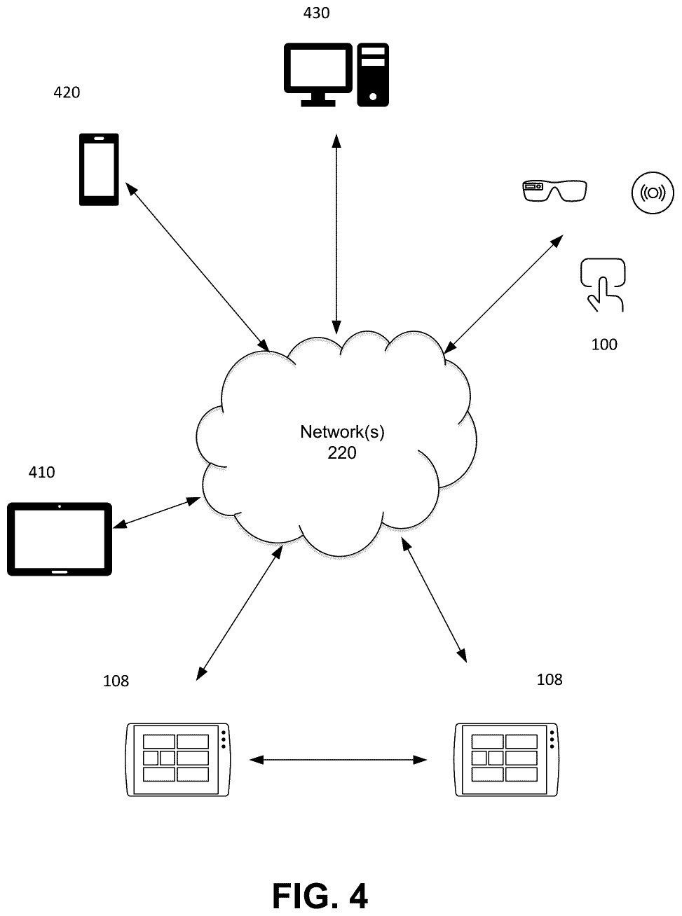

FIG. 4 illustrates a network diagram in which the exemplary covert visual and vibrotactile haptic communication system can or may be implemented. In addition to a basic network and being able to network from transmitting device to transmitting device, the covert visual and vibrotactile haptic communication system may network both bi- and unidirectionally with tablets 410, mobile devices 420 belonging to both players and coaches alike, desktop computer systems 430, along with other covert visual and vibrotactile haptic communication systems 100. Persons having skill in the art will appreciate that the exemplary covert visual and vibrotactile haptic communication system's capability to network with other devices offers a greater level of capability in recording individual player statistics.

By way of example, and not limitation, an embodiment of the invention employs the ESP32 series microcontroller unit which employs either a Tensilica Xtensa LX6 microprocessor in both dual-core and single-core variations, Xtensa LX7 dual-core microprocessor or a single-core RISC-V microprocessor and includes built-in antenna switches, RF balun, power amplifier, low-noise receive amplifier, filters, and power-management modules. Persons skilled in the art will readily appreciate that other microcontroller units are capable of performing the same or similar functions as the ESP32 system, and can be readily implemented.

It will be understood by persons having skill in the art that memory storing computer readable instructions that, when executed by the at least one processor, cause the covert visual and vibrotactile haptic communication system, by at least one processor, to perform the steps of certain functions such as, but not limited to, system initialization, system logging, power management, system configuration, game state, peer-to-peer networking, display information, vibro-haptic signaling, input functions, fingerprint sensor technology and web server functionality.

Persons skilled in the art will further understand that memory storing computer readable instructions that, when executed by the at least one processor, cause the covert visual and vibrotactile haptic communication system to execute the steps of certain software modules. Such software modules include, but are not limited to the following functions: System software which covers initialization, logging, power management, supporting the system state (i.e. locked, unlocked, standby, etc.). Configuration supports configuration of each module as well as global options. Configuration also includes configuration of the physical configuration (e.g. available hardware), user preferences, player role, and game rules. Game state provides thread-safe read-write access to local game parameters by other modules and publishes updates to other modules. A peer-to-peer network module maintains authenticated and secure inter-player device network as devices are added or removed, subscribes to game-state updates, supports broadcast or point-to-point communication of game-state changes from web server or local user input (as configured and subject to game rules), publishes game-state updates, and receives state from other player devices. A display module subscribes to game-state updates to provide visual information to the player, displays configuration based on player/role and hardware display capabilities and supports displays directly wired or connected via Bluetooth. The vibro-haptic module subscribes to game-state updates to alert the player using configured intensity and pattern. An input module publishes game-state updates through the game state module and supports trackpad, rotary encoder, touch-screen, etc. A fingerprint sensor module is used to authenticate a user and update device state (locked vs unlocked). Finally, a web server module manages secure web connectivity over 802.11 (Wi-Fi) using an external access point or an internal “soft” access point, provides a web interface for coach or manager (as permitted by game rules), provides web service to interact with game officials or facility systems (as supported and permitted), and publishes game-state updates received via “post” requests.

The invention can be further implemented as machine readable instructions detailing a method for operating a covert visual and vibrotactile haptic communication system wherein one or more computers control functions such as, but not limited to, powering up and starting the system; saving the system state; updating the system status based on user input, updating the system status based on status received from other transmitter and/or receiver units or remote interface; updating the system status based on state received from other units of the system; and transmitting state updates to receiver units.

Persons having skill in the art will appreciate that the invention can be further implemented as computer readable instructions for performing the aforementioned functions in differing order. Furthermore, it will be understood that a computer can be programmed to perform similar functions or analogous functions depending on the system used based on factors such as, but not limited to, the type of sport, the number of participants, and the rules regarding the use of communication systems.

As permitted by the specific governing rules of each sport, the system can interface with other participants and services using web services or any other specified protocols. The participant can include a designated person such as a coach or manager. The designated person has an option to use a browser-based application via a computer or mobile device to communicate with players from a secure location such as a baseball dugout. The system can also integrate with other services or participants that might be available (game officials, scoreboards, weather services, etc.).

The information signal can be transmitted using various network transmission forms. The signal can be sent using various transmission standards and protocols over various frequency bands and network layers. End-to-end encryption is used to ensure the security and privacy of the communication using industry standards (SSL/TLS, IPSec, zero trust, etc.). Optionally, the system supports biometric authentication through the use of a fingerprint sensor for auditing purposes or in case devices are misplaced, stolen or cloned.

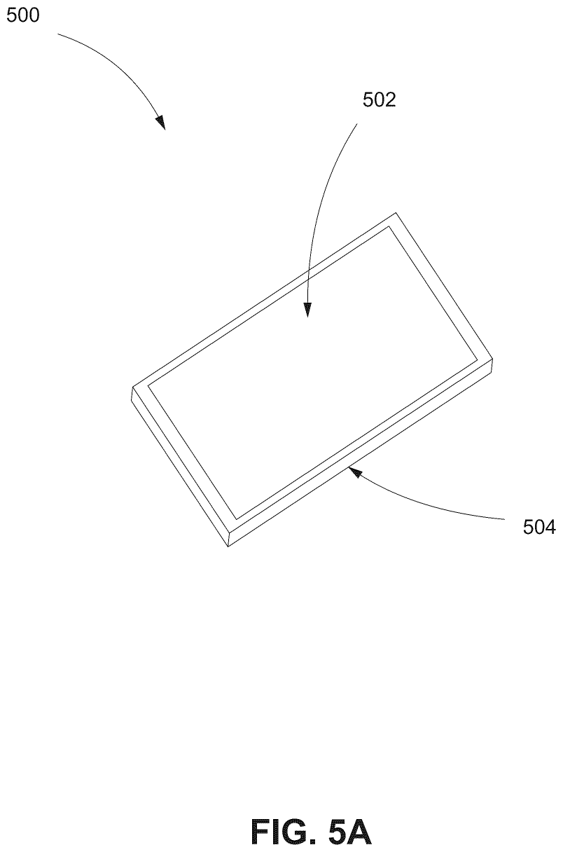

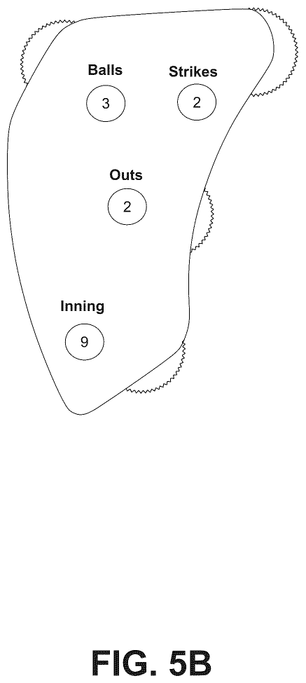

FIG. 5A illustrates a covert input device which can be integrated with, or serve as a central processing unit which can serve as a sending unit, a receiving unit, or a general computer for the covert visual and vibrotactile haptic communication system in accordance with an embodiment of the invention. Persons skilled in the art will appreciate that a central processing unit can serve as a transmitting device which is able to send signals to the vibrotactile haptic device, the hands-free visual interface, the covert input device, and other peripheral components utilized by the system. Such a transmitting device includes at least one processor and memory having computer executable instructions which can serve as a computer system in which the covert visual haptic sports communication system is integrated and implemented. The transmitting device can be networked with receiving devices as well as other transmitting devices.

Persons skilled in the art will further appreciate that the central processing unit can serve as a receiving device which is able to receive signals from a transmitting device, and send signals to the hands-free visual interface, the covert input device, and other peripheral components utilized by the system. Such a receiving device includes at least one processor and memory having computer executable instructions which can serve as a computer system in which the covert visual haptic sports communication system is integrated and implemented. The receiving device can be networked with receiving devices as well as other transmitting devices.

In embodiments of the invention, the central processing unit can be implemented as a wearable display which uses a combination of features to limit unintended viewers, including but not limited to, a manual or automatic physical covering over the display, louvers or micro louvers which limit viewing angles of the central processing unit which includes a display.

In another embodiment of the invention, the CPU unit includes a covert input device. In embodiments of the invention, the covert input device is networked to other components of the covert visual and vibrotactile haptic communication system via a wireless network such as, but not limited to, Bluetooth or near field communication (NFC). As a component of an IoT embedded system, the covert input device includes one or more finger swiping units consisting of touchpad interfaces which allows for players to communicate covert messages with one or more other players and/or coaches by creating finger swiping gestures which are only understood by intended persons. In contrast to pressing buttons which can be understood by observers, using a finger swiping device enables players and or coaches to create covert messages which are much more difficult to decipher. Persons skilled in the art will readily appreciate that a swiping unit can be programmed to recognize various swiping patterns which can be transmitted as data to other devices networked in an exemplary covert visual and vibrotactile haptic communication system. Persons skilled in the art will further appreciate that a covert input device so configured can serve as a part of a graphical interface to provide basic game data to hands-free visual interfaces in the convert visual and vibrotactile haptic communication device.

FIG. 5B illustrates an input device which can take on the appearance of an umpire indicator configured to transmit data among the components of a covert visual and vibrotactile haptic communication system in accordance with an embodiment of the invention. A similar covert input device would include one or more unmarked scroll wheel mechanisms known and understood in the art. Scroll wheels typically utilize any form of rotary encoder which converts the angular position or motion of a wheel, shaft or axle into analog or digital signals which can then be interpreted by one or more processors utilizing software. In various embodiments of the invention, a covert input device having a single scroll wheel could be placed in numerous places on a participant's person or uniform so as to create a covert means of communicating with other participants and/or coaches. A single scroll wheel can allow a participant to create a number of various covert signals by simply moving a finger. In other embodiments of the invention, multiple scroll wheels can utilized to create a device similar to an umpire indicator, and can be used as a covert input device in the system with multiple inputs and means of sending signals to more than one participant. Persons skilled in the art will appreciate that such a covert input device can be configured to communicate with or serve as a transmitting device which is able to send signals to the vibrotactile haptic device, the hands-free visual interface, the covert input device, and other peripheral components utilized by the system. In embodiments of the invention, the covert input device is networked to other components of the covert visual and vibrotactile haptic communication system via a wireless network such as, but not limited to, Bluetooth or near field communication (NFC). Persons skilled in the art will further appreciate that a covert input device so configured can serve as a part of a graphical interface to provide basic game data to hands-free visual interfaces in the convert visual and vibrotactile haptic communication device.

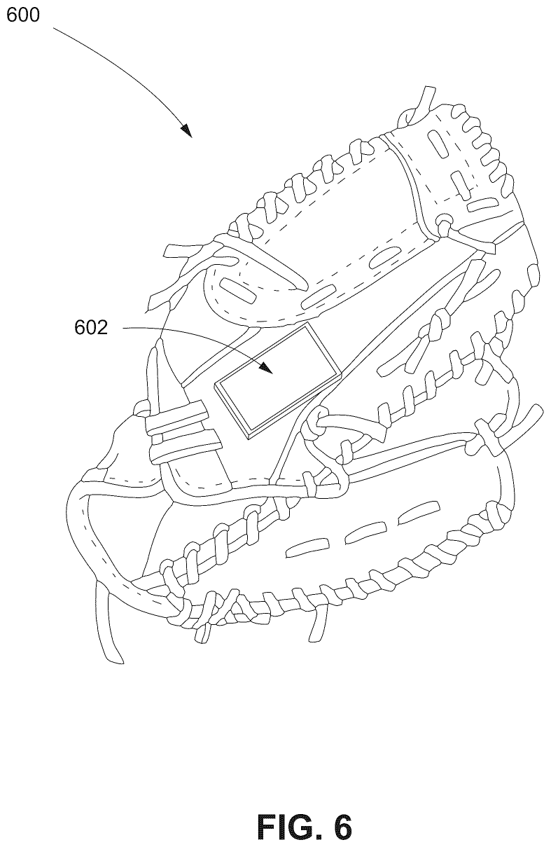

FIG. 6 illustrates a baseball glove with a covert input device attached. In one embodiment of the invention, a covert input device with a display is integrated into a pitcher's glove. Such a display and covert input device enables a pitcher to engage in two-way communication with a catcher, manager or other coach. In another embodiment of the invention, the covert input device, the hands-free visual interface, and a central processing unit are integrated into one unit. Persons skilled in the art will appreciate that such an integrated system can network with other like devices as well as other components of the covert visual and vibrotactile haptic communication system.

The incorporation of a finger swiping device 602 allows for players to communicate covert messages with one or more other players and/or coaches by creating finger swiping gestures which are selected and interpreted as messages to be sent only to intended persons. In embodiments of the invention, the finger swiping device 602 is networked to other components of the covert visual and vibrotactile haptic communication system via a wireless network such as, but not limited to, Bluetooth or near field communication (NFC). As a component of an IoT embedded system, the finger swiping device can send and/or receive data to and from other devices on the covert vibrotactile haptic communication system. Persons skilled in the art will understand that the central processing unit can be integrated with finger swiping device, the visual display unit and the central processing unit and attached to a baseball glove by numerous methods known and appreciated in the art. Persons skilled in the art will also appreciate that numerous means and methods exist to protect such an integrated unit from impacts, weather, etc.

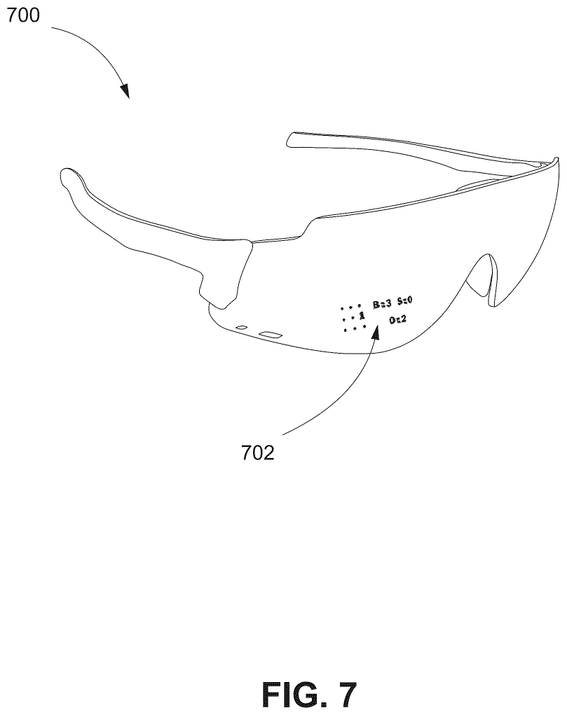

FIG. 7 illustrates a pair of augmented reality eyeglasses 700 in which a hands-free visual interface of the covert visual and vibrotactile haptic communication system can be embodied. Persons having skill in the art will understand augmented reality, or AR, eyeglasses superimpose a layer of digital content onto one or more lenses. Persons having skill in the art will appreciate that a networked hands-free visual interface 702 can be altered and mounted to a catcher's mask so as to create a heads-up display unit. Such a heads-up display unit will be minimally obtrusive to a baseball catcher's field of vision. Moreover, a heads-up display unit can be networked with a CPU unit as a receiver unit to receive signals from a pitcher, a base coach, other players, or a manager. In embodiments of the invention, the augmented reality glasses are networked to other components of the covert visual and vibrotactile haptic communication system via a wireless network such as, but not limited to, Bluetooth or near field communication (NFC). As a component of an IoT embedded system, the augmented reality eyeglasses can send and/or receive data to and from other devices on the covert vibrotactile haptic communication system. Persons skilled in the art will appreciate that other networking technologies are available to implement such a component into the covert visual and vibrotactile haptic communication system.

In embodiments of the invention, the augmented reality eyeglasses 700 may also include at least one articulating ear bud, a radio transceiver, and a heat sink mechanism to absorb heat from the LED light engine, to keep it cool and to allow it to operate at full brightness. Other embodiments of the invention may include vibrotactile devices in which a vibrating signal may be received and understood by the player wearing the augmented reality eyeglasses.

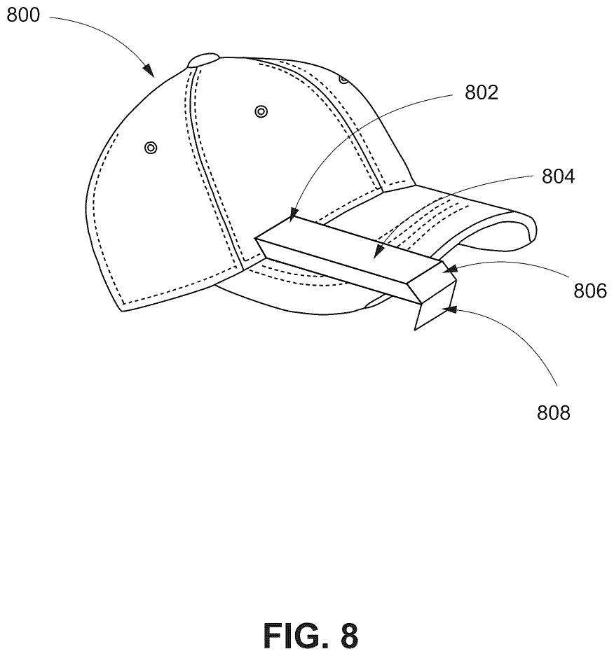

FIG. 8 illustrates a baseball cap with a hands-free visual interface attached. In embodiments of the invention, a baseball player can use a head-up display integrated into a baseball cap. In one exemplary embodiment of the invention, the baseball cap 800 employs a microdisplay unit 802 which sends a displayed image along an optical path 804 where the image is reflected by a mirror 806 to a partially reflective surface such as a partial mirror 808. In other embodiments of the invention, a RGB projector unit may be used. As a component of an IoT embedded system, the hands-free visual interface can send data to other devices on the covert vibrotactile haptic communication system. A baseball player can also use other peripheral units along with a CPU unit to both send and receive communications to a pitcher, catcher, other players, or to coaching and management staff. The object of implementing such a heads-up display unit is to be minimally obtrusive to a baseball catcher's field of vision while still being comfortable to wear.

It will become readily apparent to persons skilled in the art that a microdisplay unit can be chosen from numerous microdisplay units known and appreciated in the art. In one embodiment, the microdisplay unit can be a LED unit. In another embodiment, the microdisplay unit can be a LCD unit. In embodiments of the invention, the microdisplay unit is networked to other components of the covert visual and vibrotactile haptic communication system via a wireless network such as, but not limited to, Bluetooth or near field communication (NFC).

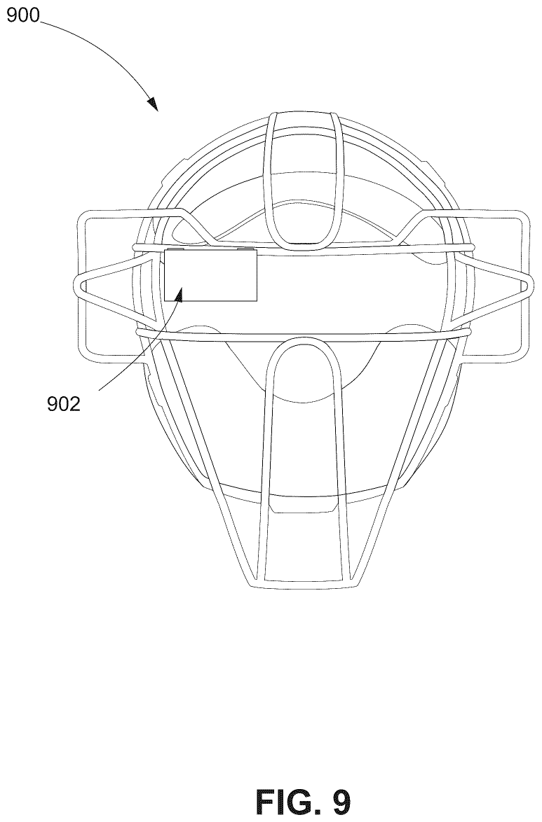

FIG. 9 illustrates a baseball catcher's mask with a hands-free visual interface attached. In embodiments of the invention, a catcher can use a head-up display 902 integrated into a catcher's mask 900. In embodiments of the invention, the hands-free visual interface is networked to other components of the covert visual and vibrotactile haptic communication system via a wireless network such as, but not limited to, Bluetooth or near field communication (NFC). As a component of an IoT embedded system, the hands-free visual interface can send and/or receive data to and from other devices on the covert vibrotactile haptic communication system. By way of example, and not limitation, a transparent OLED display, also known as TOLED includes a pixel dimension of 128×56 and a width of 1.51 inches. Such a transparent OLED can utilize a pixel color which light-blue when lit and about 70% transparent when not lit. Such a display supports various interfaces such as, but not limited to, I2c and SPI interfaces. A processor such as, but not limited to, a 3.3v Seceduino/Arduino UNO Clone and Solomon Systech SSD1309 integrated controller can be utilized. Persons skilled in the art will appreciate the numerous means and methods in which a transparent head-up display can be attached to a catcher's mask such as, but not limited to, clamps, screws, rivets, welds and adhesives. Alternatively, just as with the aforementioned baseball cap with a hands-free visual interface attached, a microdisplay unit or projector unit which sends a displayed image along an optical path where the image is reflected by a mirror to a partially reflective surface such as a partial mirror. A catcher can also use other peripheral units along with a CPU unit to both send and receive communications to a pitcher, other players, or to coaching and management staff.

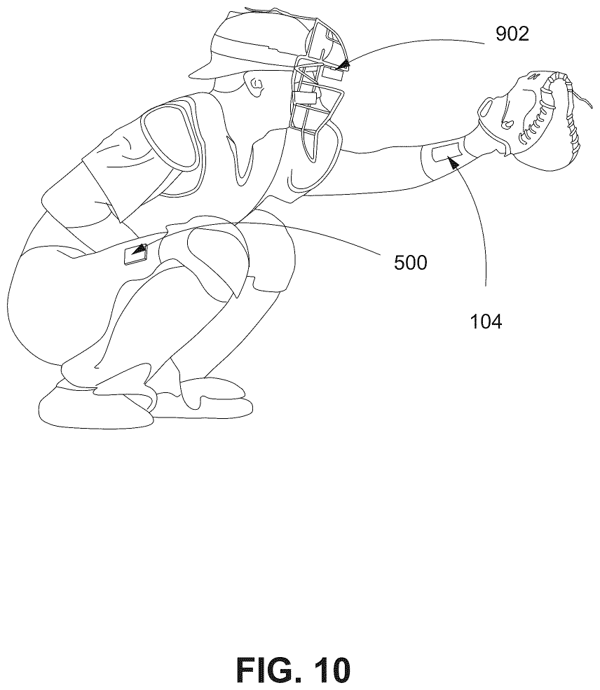

FIG. 10 illustrates a baseball catcher utilizing the covert visual and vibrotactile haptic communication system in accordance with an embodiment of the invention. In this view, the catcher employs a covert input device which can be a touchscreen module 500. The covert input device is attached to location on the body convenient to each specific player's needs. As illustrated, a baseball catcher can simply swipe the covert input device positioned on the catcher's thigh. The catcher further employs the head-up display unit as illustrated in FIG. 9.

The catcher can wear a haptic device 104 where information is sent to a player both visually and haptically. Such a haptic interface sends a vibrotactile signal produced by a motor in the display to induce a tactile vibration sensation to alert the player that new information is present on the display. The vibrotactile signal can be configured with various patterns and intensities or even disabled based on the message type and context. In embodiments of the invention, the haptic device is networked to other components of the covert visual and vibrotactile haptic communication system via a wireless network such as, but not limited to, Bluetooth or near field communication (NFC).

Having fully described at least one embodiment of the covert visual and vibrotactile haptic communication system, other equivalent or alternative methods of implementing such an automated covert visual and vibrotactile haptic communication system according to the present invention will be apparent to those skilled in the art. Various aspects of the invention have been described above by way of illustration, and the specific embodiments disclosed are not intended to limit the invention to the particular forms disclosed. The particular implementation of the covert visual and vibrotactile haptic communication system may vary depending upon the particular context or application.

By way of example, and not limitation, the system and methods for the covert visual and vibrotactile haptic communication system described in the foregoing was principally directed to an on-field communication system for the sport of baseball. However, the system and methods for the covert visual and vibrotactile haptic communication system can be successfully implemented in sports environments where there is a stoppage in play and covert communication is necessary in proximity to a competitor or unintended observer such as, but not limited to, softball, football, lacrosse, and hockey. Furthermore, similar techniques may instead be applied to other instances where a vibrotactile haptic communication system could be employed, which implementations of the present invention are contemplated as within the scope of the present invention. For example, the covert visual and vibrotactile haptic communication system could be used for police and military units requiring covert communication. Moreover, methods and techniques from the covert visual and vibrotactile haptic communication system can be employed by security companies. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Although specific features of the covert visual and vibrotactile haptic communication system are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively, and are not limited to any physical interconnection. Claim elements and flowchart steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A covert visual and vibrotactile communication system for use in sports environments comprising one or more participant units, each unit comprising:
a. one or more covert input devices;
b. one or more vibrotactile haptic devices;
c. one or more hands-free visual interfaces; and
d. one or more central processing units having at least one processor and memory, said central processing unit networkable with the one or more covert input devices; the one or more vibrotactile haptic devices and the one or more hands-free visual interfaces.

2. The covert visual and vibrotactile communication system of claim 1 wherein the one or more participant units is networkable with one or more transmitting units, said transmitting units used for providing real-time communication with the one or more participant units.

3. The covert visual and vibrotactile communication system of claim 2 wherein the one or more central processing units having at least one processor and memory serve as transmitting units, receiving units or both transmitting units and receiving units.

4. The covert visual and vibrotactile communication system of claim 1 wherein the one or more covert input devices is a touchpad interface having one or more touchpad units.

5. The covert visual and vibrotactile communication system of claim 1 wherein the one or more covert input devices includes at least one scrolling wheel.

6. The covert visual and vibrotactile communication system of claim 1 wherein each participant unit includes a biometric identification system including a fingerprint sensor.

7. The covert visual and vibrotactile communication system of claim 1 wherein the hands-free visual interface of a participant unit consists of a heads-up-display unit attached to a baseball cap.

8. The covert visual and vibrotactile communication system of claim 1 wherein the hands-free visual interface of a participant unit consists of a heads-up display integrated with a sports mask.

9. The covert visual and vibrotactile communication system of claim 1 wherein the hands-free visual interface of a participant unit consists of a display unit attached to a central processing unit.

10. The covert visual and vibrotactile communication system of claim 1 wherein the hands-free visual interface of a participant unit consists of augmented reality glasses.

11. A covert visual and vibrotactile communication system for use in sports environments where there is a stoppage in play and covert communication is necessary in proximity to a competitor or unintended observer having one or more participant units, each participant unit comprising:
a. at least one finger swiping device;
b. at least one vibrotactile haptic device;
c. at least one heads up display;
d. a biometric identification system; and
e. a central processing unit having at least one processor and memory, said central processing unit networkable with the finger swiping unit; the vibrotactile haptic device and the hands-free visual interface.

12. The covert visual and vibrotactile communication system of claim 11 wherein the one or more participant units is networkable with one or more transmitting units, said transmitting units used for providing real-time communication with the one or more participant units.

13. The covert visual and vibrotactile communication system of claim 11 wherein the biometric identification system is a fingerprint sensor.

14. The covert visual and vibrotactile communication system of claim 11 wherein the finger swiping unit consists of a touchpad interface.

15. The covert visual and vibrotactile communication system of claim 11 wherein the hands-free visual interface consists of a heads-up-display unit attached to a baseball cap.

16. The covert visual and vibrotactile communication system of claim 11 wherein the hands-free visual interface consists of a heads-up display integrated with a sports mask.

17. A covert visual and vibrotactile communication system for use in sports environments where there is a stoppage in play and covert communication is necessary in proximity to a competitor or unintended observer, said covert visual and vibrotactile communication system comprising:
a. one or more transmitter units comprising
i. a user input device;
ii. a fingerprint sensor;
iii. a wireless transmission system;
iv. a remote interface;
V. at least one processor; and
vi. memory including computer executable instructions which, when executed by the said at least one processor, cause the covert visual and vibrotactile communication system to perform the functions of
1. update system status based on user input;
2. update system status based on state received from other units of the system;
3. save system status in memory; and
4 transmit system status updates to receiver units
b. One or more receiver units comprising
i. a visual display;
ii. privacy hardware to prevent unintended viewing;
iii. a vibrotactile haptic device;
iv. a fingerprint sensor;
v. at least one processor; and
vi. memory including computer executable instructions which, when executed by the at least one processor, cause the covert visual and vibrotactile communication system to perform the functions of
1. update system status based on user input;
2. update system status based on state received from other units of the system;
3. display system status; and
4. provide haptic signals to users as received from the one or more transmitter units.

18. The covert visual and vibrotactile communication system for use in sports environments of claim 17 wherein the one or more transmitter units and the one or more receiver units are networkable with one another and one or more external transmitting units, said external transmitting units used for providing real-time communication with the one or more transmitter units and the one or more receiver units.

19. The covert visual and vibrotactile communication system for use in sports environments of claim 18 wherein the hands-free visual interface consists of a heads-up-display unit attached to a baseball cap.

20. The covert visual and vibrotactile communication system for use in sports environments of claim 18 wherein the hands-free visual interface consists of a heads-up display integrated with a sports mask.
